(19) United States
(12) Patent Application Publication
(10) Pub. No.: US 2017/0185977 A1
(43) Pub. Date: Jun. 29, 2017

(54) METHODS, SYSTEMS, AND COMPUTER READABLE MEDIA FOR ELECTRONICALLY GUARANTEEING PAYMENT OF BILLS

(71) Applicant: MasterCard International Incorporated, Purchase, NY (US)

(72) Inventors: Andres Guillermo Lopez, Yonkers, NY (US); Juan Carlos Leonardo Wiley Garcia, Ossining, NY (US); John Anthony Gioacchini, Yorktown Heights, NY (US); Bryan Jacob Wexler, Melville, NY (US); Stephen Anthony Parento, White Plains, NY (US)

(21) Appl. No.: 14/980,896

(22) Filed: Dec. 28, 2015

(51) Int. Cl. G06Q 20/10

(52) U.S. Cl. CPC G06Q 20/102

(57) ABSTRACT

Methods, systems, and computer readable media for electronically guaranteeing payment of bills are provided. An exemplary method is performed at a utility payment management server (UPMS) that includes at least one processor. The method includes receiving, via a communications network, payment information including a payment card number or an account number communicated from a computing platform. The method further includes receiving, from the computing platform, an indication of a monetary amount required to pay one or more bills, or portions thereof. The method further includes electronically allocating the monetary amount required to pay the one or more bills by placing a temporary lien on funds associated with the payment card number or the account number and electronically releasing the monetary amount to one or more providers according to a predetermined schedule as communicated by the computing platform.

### TECHNICAL FIELD

The subject matter described herein relates to improved methods and systems for electronically allocating funds for payment of goods and/or services. More particularly, the subject matter described herein relates to systems, methods, and computer readable media for electronically guaranteeing payment of bills.

### BACKGROUND

In certain situations, some individuals are unable to access and/or maintain access to public or private utilities and/or basic services, such as power, rent, gas, cable, insurance, or even water, as the service provider cannot guarantee that the individuals will be able to pay for the respective services, once connected. Those individuals may be unable to access utilities because they have either no credit or what is deemed “bad” credit. This is problematic to all parties involved, as underserved individuals are susceptible to unsafe living conditions, and utility companies lack incentives for providing utilities to individuals who may not otherwise be able to afford them.

Where an individual has access to utilities and/or other services, billing and payment implementations require either a customer to receive and pay a paper bill or the customer must log in to a specific account, view the account statement, specify a payment type, and authorize a payment to the specific merchant (i.e., utility service provider). This process is both time consuming and tedious, as a customer must recall multiple usernames and/or passwords to pay bills via multiple online platforms. The customer must also manually keep track of when a payment for a bill is due. Furthermore, the utility provider has no guarantee that a customer will pay on a recurring basis.

Banks provide online bill pay interfaces that allow customers to pay bills from multiple utility providers without having to log in to multiple different utility accounts. However, some individuals may not have bank accounts and thus may not have access to an online bill pay interface. Where a user does have a bank account, the account number must be linked and/or otherwise provided directly to multiple utility providers, which increases the risk of account fraud and/or security breaches.

Accordingly, there exists a need for improved methods, systems, and computer readable media for electronically guaranteeing payment of bills, for example, via a single computing platform that collects multiple bills for payment, without having to link or provide a bank account number thereto.

### SUMMARY

According to one aspect, the subject matter described herein relates to methods, systems, and computer readable media for electronically guaranteeing payment of bills. An exemplary method is performed at a utility payment management server (UPMS) that includes at least one processor. The method includes receiving, via a communications network, payment information including a payment card number or an account number communicated from a computing platform. The method further includes receiving, from the computing platform, an indication of a monetary amount required to pay one or more bills, or portions thereof. The method further includes electronically allocating the monetary amount required to pay the one or more bills by placing a temporary lien on funds associated with the payment card number or the account number and electronically releasing the monetary amount to one or more providers according to a predetermined schedule as communicated by the computing platform.

In some embodiments, an exemplary system for electronically guaranteeing payment of bills is provided. The system includes a computing platform configured to communicate payment information and an indication of a monetary amount required to pay one or more bills, or portions thereof, across a communications network. The system further includes a utility payment management server (UPMS) comprising at least one processor, wherein the UPMS is configured to receive the payment information and the indication of the monetary amount from the computing platform. The UPMS is configured to electronically allocate the monetary amount required to pay the one or more utility bills by placing a temporary lien on funds associated with the payment card number or the account number, and electronically release the monetary amount to one or more providers according to a predetermined schedule as communicated by the computing platform.

The subject matter described herein may be implemented in hardware, software, firmware, or any combination thereof. As such, the terms “function”, “node”, or “module” as used herein refer to hardware, which may also include software and/or firmware components, for implementing the features being described. In one exemplary implementation, the subject matter described herein may be implemented using a non-transitory computer readable medium having stored thereon computer executable instructions that when executed by the processor and memory of a computer control the computer to perform steps.

Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

The subject matter described herein includes exchanging messages across a communications network, wherein the messages include payloads having payment information (payment card numbers, account data, or the like), balance information, and/or transaction information associated with guaranteeing electronic payment of goods and/or services. The subject matter described herein also includes implementing electronic pre-allocation or holding funds, to effectively place a lien on those funds until a predetermined settlement date such that the funds can only be used to pay bills for goods and/or services. In some embodiments, implementing an electronic guarantee for bills includes invoking one or more application programming interfaces (APIs) configured to assist otherwise distinct applications with sharing data across a communications network.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a schematic diagram illustrating exemplary network architecture for electronically guaranteeing payment of bills according to an embodiment of the subject matter described herein;

FIG. 2 is a message diagram illustrating exemplary electronic messaging exchanged between various computing entities for electronically guaranteeing payment of bills according to an embodiment of the subject matter described herein;

FIG. 3 is a block diagram illustrating an exemplary system for electronically guaranteeing payment of bills according to an embodiment of the subject matter described herein; and

FIG. 4 is a schematic block diagram illustrating an exemplary process for electronically guaranteeing payment of bills according to an embodiment of the subject matter described herein.

### DETAILED DESCRIPTION

In accordance with the subject matter disclosed herein, methods, systems, and computer readable media for electronically guaranteeing payment of bills (e.g., utility bills) are provided. In some embodiments, methods, systems, and computer readable media described herein are not manual (e.g., not capable of performance by a human being), but rather are accomplished by virtue of electronic messaging exchanged between network entities (e.g., computing platforms, electronic entities, or nodes) across a communications network to facilitate collection and/or integration of multiple bills, while electronically allocating or “earmarking” money to pay the utility bills on a recurring basis.

The methods, systems, and computer media described herein advantageously obviate the need for performing manual processes (e.g., delivering paper bills, delivering a check or cash as payment) on a recurring basis, and expand provision of utilities to larger portions of the population via electronically guaranteeing the payment of utility bills.

The methods, systems, and computer readable media described herein advantageously benefit multiple parties to a transaction, including the customer (e.g., also referred to as a “consumer” and/or a “cardholder”) and the utility provider (e.g., referred to as a “merchant”). For example, electronically guaranteeing payments provides the utility or service provider with an increased level of assurance that a customer can pay for utility services provided, while the customer may experience discounted rates, improved quality of service, rebates, incentives, or the like. The methods, systems, and computer readable media described herein may advantageously increase access to various utilities, thereby decreasing the cost of the respective utilities.

As used herein, the term “utility” refers to any good, service, and/or membership obtained from any residential, commercial, public, or private service provider, including, but not limited to, for example, electricity or electrical power, gas, wired or wireless telephone, television (TV) service (e.g., via cable, satellite, streaming, fiber, etc.), Internet services, water, sewage, trash and/or recycling collection, home security installation and/or monitoring, irrigation services, lawn care services, rent payments, lease payments, neighborhood association payments (e.g., homeowner's association fees/bills), insurance payments, school associations (e.g., PTA or the like), payment of insurance premiums (e.g., car insurance, health insurance, life insurance, disability insurance, or the like), workers compensation insurance, workers union membership payments, tuition payments, and the like.

As used herein, the term “allocating” refers to electronically earmarking, identifying, and/or otherwise designating funds to be used to pay one or more specific utility bills, or portions thereof, on a recurring basis. Fund allocation effectively applies an electronic lien on funds accessible and/or associated with a payment card or a payment account (e.g., a bank account), to funds within an account, and/or to funds associated with a customer's card or account, whether the card or account is prepaid or non-prepaid, for the recurring electronic collection and payment of utility bills.

Electronically collecting, allocating, and/or holding funds associated with a customer card or account facilitates implementation of a revolving guarantee for merchant utility providers, which is advantageous to all parties of utility purchase transactions as described herein. For example, and in consideration for allowing funds to be pre-allocated and/or held for payment of utility bills on a recurring basis, customers may receive discounts or other incentives regarding utility services. In addition to this, individuals that may typically be denied access to utility services can now access and receive such services by enrolling in a service that guarantees payment of utility bills, or portions thereof, on a recurring basis.

Reference will now be made in detail to exemplary embodiments of the subject matter described herein, examples of which are illustrated in the accompanying drawings. Wherever possible, the same reference numbers will be used throughout the figures, also “FIGS.”, and refer to the same or like entities.

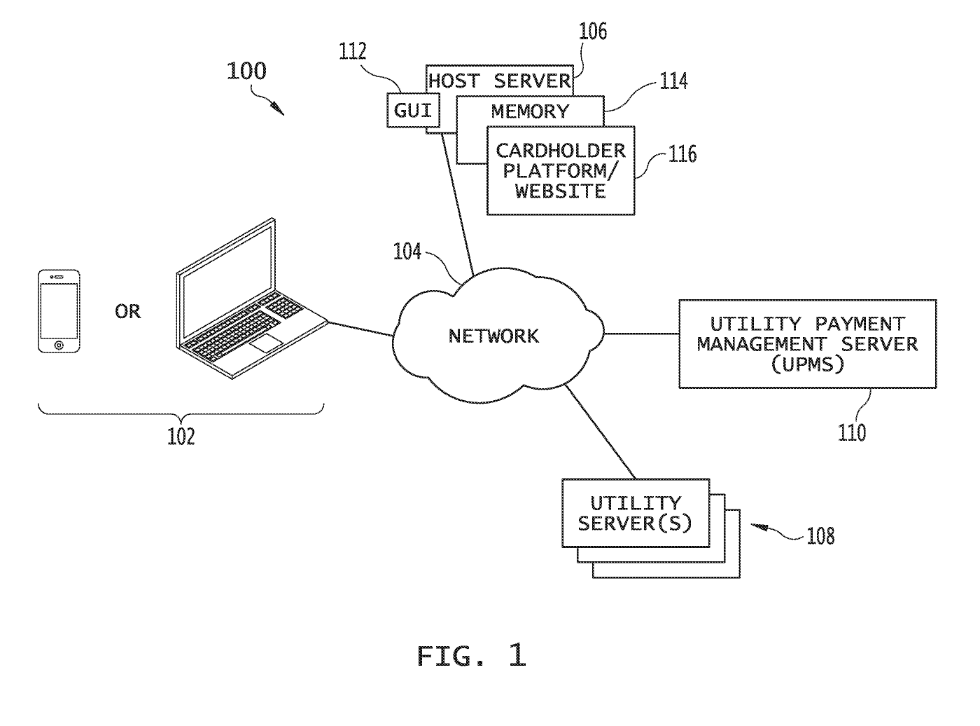

FIG. 1 is a schematic diagram illustrating an exemplary network environment or network architecture 100 associated with electronically guaranteeing payment of bills according to an embodiment of the subject matter described herein. In some embodiments, architecture 100 includes multiple different and/or distinct network nodes or entities for facilitating guaranteed payment of utility bills via pre-allocating or earmarking of funds on a recurring basis for satisfying payments associated with utility goods and/or services as instructed via a user element (UE), generally designated 102.

In some embodiments, a utility customer utilizing UE 102 can enroll in a program or service configured to consolidate or collect data associated with multiple different bills (e.g., utility bills) at a single computing platform, which also presents the multiple different bills for payment. The customer's funds can be electronically collected, allocated or earmarked, and then released to the multiple different companies on a recurring basis, in some aspects according to a predetermined schedule (e.g., a daily, weekly, monthly, bi-weekly, quarterly schedule, or the like). Notably, architecture 100 obviates the need for the traditional (i.e., manual) delivery, collection, and payment of bills, for example, utility bills. In addition to this, utility providers are incentivized to grant access to a greater number of individuals via electronically guaranteed payments, in some aspects to individuals that may otherwise be denied access to such services because of no credit or bad credit. In some embodiments, various utility providers can be individually provided with an electronic alert or message for informing each utility provider that that a payment is made and/or that funds have been allocated thus incentivizing and expanding utilities to a larger customer base.

UE 102 may include any electronic device configured to access a communications network 104 and communicate payment information to a host server 106. Exemplary UEs 102 include any type of mobile or non-mobile device such as a phone, a computer, a smart device, a laptop computer, a tablet computer, a desktop computer, a smart planner or organizer, a smart television, a wearable computer (e.g., a watch or eyeglass mounted computer), or the like. For illustration purposes only, UE 102 is illustrated as including a mobile phone or a laptop computer; however, UE 102 may be any type of communication device.

UE 102 may access network 104 via signaling across any type of wired or wireless connection or interface (e.g., a WAN, a LAN, a WiFi connection, a radio access connection, or the like). Network 104 can include any type of communications network through which a cardholder platform website located on a host server 106 can be accessed for enrolling a customer within a utility bill consolidation, integration, and/or collection service. Host server 106 may be hosted by a third party entity (e.g., a payment clearinghouse, or the like) for enrolling customers, namely, prepaid or non-prepaid cardholders, within a utility bill consolidation and collection service, which is both customer facing (i.e., faces UE 102) and merchant (i.e., utility provider) facing. Thus, host server 106 can advantageously be accessed by multiple, different parties to a utility bill transaction. For example, customers can access host server 106 via signaling across network 104 via UE 102, and merchant utility providers, using respective utility servers generally designated 108, may also access host server 106 via signaling packet communications across network 104.

In some embodiments, network 104 includes a packet-based communications network (e.g., the Internet) that is accessed by UE 102 via a communications interface. Although a packet-based network is shown for illustrative purposes, the subject matter described herein is not limited to a packet-based network. Any type of communications network through which messages can be exchanged electronically between computing platforms may be used without departing from the scope of the subject matter described herein. Such communications networks may include packet-based networks, circuit-switched networks, and combinations of packet-based and circuit-switched networks. Although not shown, each individual entity (e.g., 102, 106, 108, and 110) associated with architecture 100 may reside in an individual (e.g., public or private) network, which may include a same network or different networks, and are not shown for illustration purposes. Network 104 facilitates communication of data via packets or packet-based messages, which may be communicated between network entities according to any desired communication protocol as known in the art (e.g., IP, HTTP, TCP, UDP, SIP, or the like).

Network 104 may be accessed via one or more access nodes, endpoints, or ingress points such as one or more gateways or switches (not shown). For illustration purposes only, a single network 104 is illustrated for generically depicting the Internet or cloud. Network 104 may support one or more cloud based entities or services, however, as known in the art, architecture 100 may also include and/or facilitate communications for multiple different (e.g., individual or privately managed) networks. Network 104 may also support communications across multiple different networks for accessing utility bill collection and payment allocation services hosted or provided by various individual entities, such host server 106 and/or a utility payment management server (UPMS) 110.

A customer, via UE 102, may access a host server 106 via a customer or cardholder platform 116, such as a website, a mobile application, or the like that resides in a memory element 114 of host server 106. In some embodiments, host server 106 includes a graphical user interface (GUI) 112 by which the cardholder (customer) can view utility bills, set up recurring payments, determine a payment schedule, view account balances for various different utility accounts, or the like. GUI 112 can comprise a display or interface by which a customer can view multiple utility bills and determine an amount of funds to allocate each payment cycle to be paid to one or more utility providers. GUI 112 may also display multiple different utility account balances and/or various account information (e.g., a minimum payment, a payment cycle, a utility usage, or the like). In some aspects, host server 106 includes a mobile application or website access interface associated with a third party service provider that is independent from the utility companies.

Host server 106 includes functionality for communicating with each of the other network entities for facilitating utility bill consolidation, payment, and collection. Host server 106 includes functionality for communicating with a customer via UE 102, a plurality of different utility servers 108, and UPMS 110. In some embodiments, host server 106 is a customer facing, merchant (utility service provider) facing, and merchant service (UPMS 110) facing entity configured to receive payment information communicated via UE 102, billing and/or account information communicated by utility servers 108, and payment transaction information communicated by UPMS 110. That is, host server 106 includes a computing platform that is a customer facing platform and accessible by a customer, UPMS 110, and the utility providers via utility servers 108.

In some embodiments, host server 106 is configured to collect, consolidate, and optionally integrate billing information received from multiple different utility service providers. Host server 106 may receive, consolidate, and integrate electronic information regarding utility bill amounts, balances, and/or various account information from one or more privately hosted utility servers 108 associated with a plurality of different utility providers. Notably, host server 106 includes a single computing platform configured to receive, consolidate, integrate, and visually display multiple bills from multiple third party utility providers to a customer via UE 102, and then submit those bills for payment to UPMS 110. UPMS 110 is configured to allocate funds associated with a customer's account, and pay utility companies on behalf of the customer. Not only do methods, systems, and computer readable media herein reduce the need for paper bills and manual utility bill payment and processing, but also UPMS 110 also advantageously pre-allocates funds by placing an electronic hold or lien on the funds. This advantageously assures utility providers that a customer can pay for utilities, or at least a portion thereof, during a given time period (e.g., a week, a month, etc.). In some embodiments, host server 106 and/or UPMS 108 are configured to communicate an electronic alert a utility provider when a customer does not have the funds available to earmark for bill payment, so that the utility provider can proactively deal with the situation.

Utility servers 108 may include privately hosted servers configured to communicate packets across network 104, where the packets include payloads representing billing, account balance, and/or utility account information. In some embodiments, host server 106 and utility servers 108 communicate and/or exchange billing and payment information via an application programming interface (API) configured to assist data sharing. Notably, host server 106 includes computing platform that is interoperable among various systems (e.g., agnostic). Host server 106 is configured to and/or has functionality for consolidating utility billing data, utility account information, utility balance information, or the like, from multiple (private) servers and presenting such information to the customer via UE 102. Host server 106 also includes functionality for exchanging payment information, payment transaction information, transaction history information, and/or balance information with UPMS 110. In some embodiments, host server 106 includes functionality for monitoring billing information from multiple utility servers 108 either by leveraging existing API information (e.g., via polling APIs), for example, to poll utility servers 108 for specific account and/or billing information.

Still referring to FIG. 1 and in some embodiments, UPMS 110 is configured to allocate funds prior to settlement of the utility bill. UPMS 110 is configured to pre-allocate funds associated with a payment card, or funds at an customer's issuing financial institution (e.g., a bank) to place a hold on the funds until a given settlement date. The settlement date (i.e., when the utility provider actually receives the funds) may be set by the customer, the utility service provider, or both, and agreed to by both parties. In some aspects, UPMS 110 is configured to allocate funds daily, weekly, bi-weekly, monthly, or on an otherwise recurring basis as decided by a customer and each utility company, so that settlement of the allocated amount is processed on a pre-determined, recurring basis.

UPMS 110 is configured to communicate settlement data (e.g., a payment amount, a payment method, etc.) to utility servers 108 and transaction data (e.g., a transaction amount, a transaction date, a merchant code, a transaction code, or the like) to host server 106 via network 104. UPMS 110 is also configured to receive and optionally store payment data from host server 106. Payment data may include, for example, a card number (e.g., a prepaid or non-prepaid payment card number), an account number, and/or any other type of identifying information that may be used to authenticate a purchase (e.g., a credit card number, a credit card type, an account number, an expiration date, a postal (zip) code, a Card Verification Value (CVV), or the like). UPMS 110 is configured to receive the payment data communicated from host server 106, allocate (earmark) funds for payment of utility bills via placement of an electronic hold and/or a lien on the funds, and store the payment data for future use. UPMS 110 may then use the stored payment information for allocating funds and settling or paying utility bills on a recurring basis as set by all parties to the utility service transaction. Notably, however, the money or funds will have an electronic lien applied by UPMS 110 so that those funds can only be used for payment of utility bills.

UPMS 110 is configured to receive payment information (e.g., a card or account number) and billing information (e.g., a billed amount, a merchant code, etc.) for use in application of a hold or a lien on the customer's funds (or credit). UPMS 110 may then release the held funds until a predetermined date (e.g., a payment due date) according to a predetermined payment schedule. UPMS 110 can receive, process, and release funds on a recurring basis, which may be daily or weekly (to satisfy only a portion of a bill during a billing cycle), monthly (to satisfy a full bill during a billing cycle), or any other schedule as agreed to by the customer and utility provider. UPMS 110 may release funds to multiple utility providers on a same day and time, or release funds to different utility providers on different days or times, as specified during enrollment to a service offered by host server 106 via cardholder platform 116.

In some embodiments, UPMS 110 is configured to receive an electronic communication signifying a billed amount (e.g., an amount owed) or a balance owed to one or more merchant utilities via exchanging electronic data or information with host server 106 and place a hold on a customer's funds to satisfy the one or more utility bills. UPMS 110 then electronically communicates to each utility server 108 releasing the funds, and settling each transaction. After settlement, UPMS 110 is configured to signal transaction data, transaction information, or transaction history across packet network 104. Transaction data may include an amount of the transaction, the merchant/utility provider name, a merchant identifier, the time of payment, the date of payment, a transaction identifier, or the like. Multiple utility providers may be paid in a single (recurring) transaction, or each utility provider may be paid via multiple different (recurring) transactions. Regardless of how payments are set up, transaction data can optionally be encrypted by UPMS 110, where desired, for protecting privacy and preventing security fraud. In some aspects, transaction data may be formatted for presentation to the customer via UE 102, and the transaction data may be used to calculate any remaining balances, as needed, and remind a customer of a date that a next transaction will occur according to a schedule established by the customer, the utility provider, or both.

In some embodiments, UPMS 110 includes a centralized clearing and/or settlement facility that is owned and operated by MasterCard® International Incorporated of Purchase, N.Y., USA, for managing funds (e.g., allocating funds) and settling of financial transactions between MasterCard® and its members (e.g., customers, utility server(s) 108, or the like) for electronically guaranteeing payment of utility bills. Architecture 100 includes functionality for pre-authorizing and holding funds for satisfying utility bills until a predetermined settlement date. This advantageously provides utility providers assurance that the customer has sufficient funds to pay for the utility services according to a recurring schedule, which may be weekly to pay for a portion of a utility bill, as needed.

Notably, network entities, including host server 106 and UPMS 110, are special purpose computing devices or machines that each include hardware components (e.g., one or more processor units, memory, and/or network interfaces) configured to execute hardware and software elements (e.g., APIs, computing modules, etc.) for the purposes of performing one or more aspects of the disclosed subject matter. In addition, it should be noted that host server 106 and UPMS 110, the functionality and/or components thereof described herein constitute special purpose computers that improve the technological field of electronic bill settlement and/or electronic guaranteed transactions by obviating the need for manually collecting payments, and providing mechanisms for electronically collecting and pooling multiple utility bills from multiple different private servers at a single platform, allocating or applying liens to funds for payment of the multiple utility bills, and then settling the multiple utility bills on a recurring basis.

It will be appreciated that FIG. 1 is for illustrative purposes only and that various entities, their locations, and/or their functions described above in relation to FIG. 1 may be changed, altered, added, or removed. For example, some components and/or functions may be separated or combined into one entity, e.g., host server 106, UPMS 110, or some functionality thereof may be integrated with any other entities associated with architecture 100.

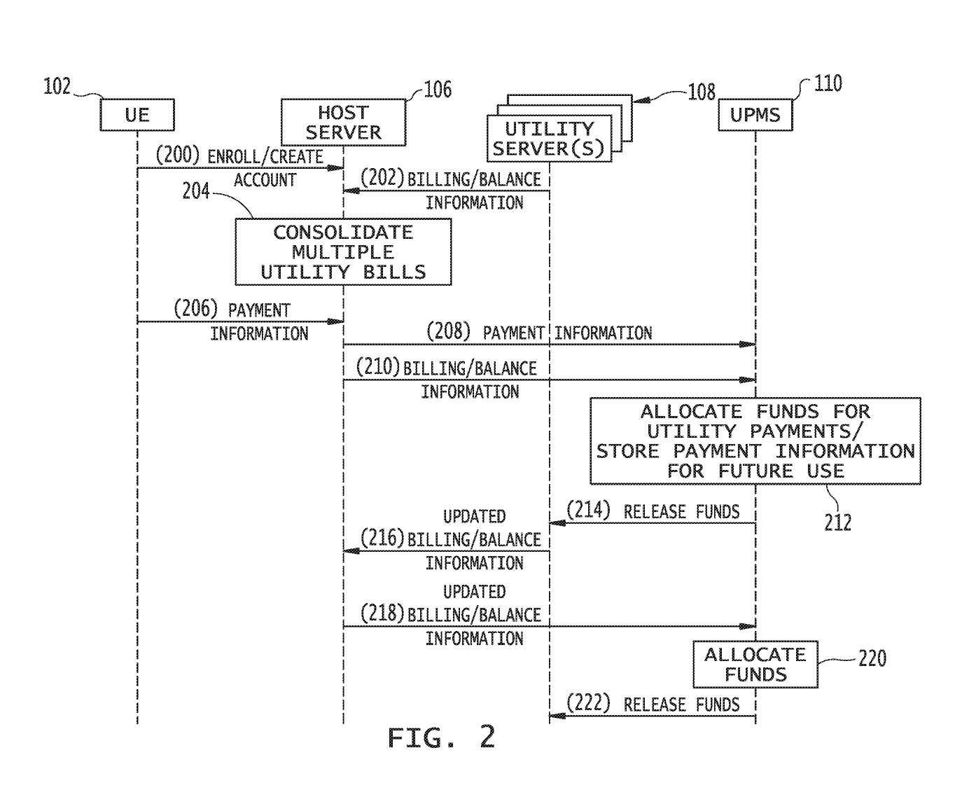

FIG. 2 is a message diagram illustrating exemplary electronic messaging exchanged between various network entities for implementing guaranteed payment of utility bills according to an embodiment of the subject matter described herein. Namely, the network entities associated with electronic payment transactions for utility services include a customer utilizing UE 102, host server 106, utility providers having privately hosted utility servers 108, and UPMS 110. UPMS 110 manages, electronically, the allocating, holding and/or placing of a lien on funds and processing recurring payment transactions as triggered by host server 106 for payment of utility bills. UPMS 110 also electronically releases monetary funds thus causing funds from a customer's card (e.g., prepaid card, non-prepaid card, etc.) or account to transfer the utility provider's account via utility servers 108.

At line 200, a customer utilizes UE 102 to enroll and/or create an account with host server 106 for implementing electronically guaranteed payment of utility bills. A customer, via UE 102, may utilize a packet network (e.g., 104) such as the Internet set up guaranteed electronic payments that occur on a recurring basis. The customer, via UE 102, establishes, customizes, and/or agrees to participate in a pre-established payment schedule for setting up recurring payment(s) of one or more utility bills via a system for placing a lien or hold on funds and earmarking those funds for the payment of specific utility bills according to the payment schedule. In consideration for agreeing to the terms and services offered by host server 106, utility providers may offer discounts, rebates, increased the quality of service, or the like.

At line 202, utility providers submit billing and balance information to host server 106. At block 204, host server 106 consolidates multiple utility bills. Host server 106 is configured to consolidate or collect the bills either electronically integrate or pool the bills for scheduling recurring payments. Host server 106 allows a customer to view one or more utility bills, set up a payment schedule by which funds will be placed on hold and/or allocated for payment of specific utility bills, and view utility account balances or account information.

At line 206, UE communicates payment information to host server 106. Host server 106 receives the payment information electronically, for example, via packets, invoking APIs, firmware, or software. Payment information includes a credit card number, a prepaid card number, an account number, a credit card type, an expiration date, a postal (zip) code, a Card Verification Value (CVV), or the like. At line 208, host server 106 communicates the payment information to UPMS 110. UPMS 110 receives the payment information and optionally stores it for use in making recurring payments as prompted by host server 106.

At line 210, host server 106 communicates utility billing and/or balance information to UPMS 110 via a packet network. At block 212, UPMS 110 receives the billing and balance information, and allocates funds to pay the utility bills by placing a lien on funds in a customer account and/or associated with a customer card (e.g., a prepaid card). UPMS 110 optionally stores the payment information received at line 208 for future use.

At line 214, UPMS 110 communicates a signal for releasing funds that were previously collected or allocated from the customer's account to the utility providers via communications to utility servers 108. Thus, UPMS 110 facilitates settlement of utility bills by releasing the previously allocated funds. After processing the payment transaction for one or more utilities and facilitating settlement, UPMS 110 can send transaction history, balance, and/or transaction information to host server 106. Transaction information includes a transaction amount, a transaction date and/or time, a merchant code (e.g., a numeric code associated with a utility provider), a transaction code, a customer identifier, or the like.

Notably, host server 106 is accessible by UE 102, utility servers 108, and UPMS 110 for guaranteeing electronic payment of utility bills. At line 216, utility servers 108 communicate updated billing and/or utility balance information to host server 106. Upon receiving the updated billing and/or balance information, host server 106 communicates the updated billing and/or balance information to UPMS 110. Lines 218 to 222 indicate recurring communications (e.g., similar to those at lines 210 to 212, respectively) for facilitating recurring payments. At line 218, host server 106 communicates the updated billing and/or balance information received from utility servers 108 to UPMS 110 across a communications network (e.g., 104, FIG. 1). At line 220, UPMS 110 allocates funds for payment to utility providers for all or a portion of a respective utility bill. At line 222, UPMS 110 releases signals the release of monetary funds to utility servers 108 thereby settling accounts established at the one or more utility provider, according to a predefined payment schedule.

In some aspects, the allocated funds may satisfy only a portion of the utility bills, and recur weekly until the month's balance is paid. In other aspects, the allocated funds satisfy the full amount of one or more utility bills. In further aspects, the allocated amount satisfies various percentages of multiple bills. For example, UPMS 110 may pay certain bills in advance of and/or before payment of other bills. For example, UPMS 110 may pay certain utilities and/or utility bills according to a prioritized list, which may be customized according to a priority specified by the customer or the merchant utility provider. Communications exchanged between host server 106 and other network entities (e.g., 108, 110) may include packets having payload data indicative of payment information (e.g., a card or account number), payment amounts, billing information, a balance, a merchant identifier, transactional information, and/or customer information.

The message flow illustrated in FIG. 2 is advantageous, as utility bill payments are transparent to all parties of the transaction, as customers (e.g., via 102) and utility providers (e.g., via utility servers 108) each know exactly when a payment is made or scheduled. In addition, and by virtue of fund allocation or application of “lien” on the customer's funds, UPMS 110 provides utility providers assurance that a customer will make or has made a payment for utilities. In some embodiments, UPMS 110 invokes an API to initiate settlement and/or the release of funds.

It will be appreciated that FIG. 2 is for illustrative purposes only and that various messages, message sequencing and/or message content described above in relation to FIG. 2 may be changed, altered, edited, or removed where necessary. For example, some messages may be separated or combined into more than one or less than one message.

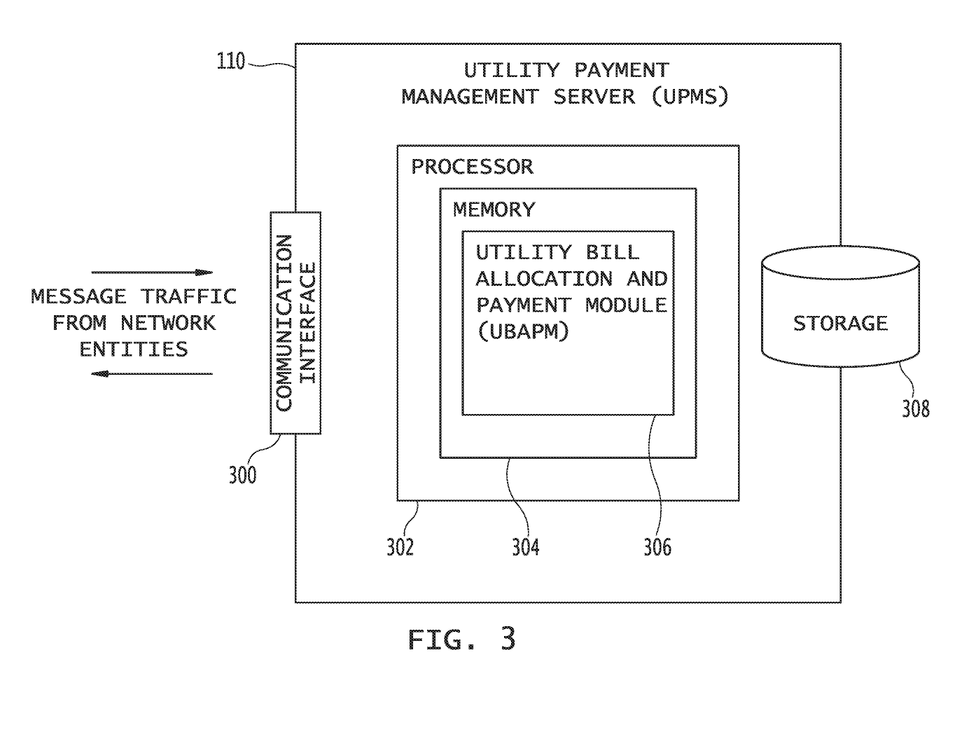

FIG. 3 is a block diagram illustrating an exemplary system (i.e., 110) for electronically guaranteeing payment of utility bills according to an embodiment of the subject matter described herein. FIG. 3 illustrates UPMS 110, which includes a system or device for facilitating guaranteed payment of utility bills, in some aspects, by placing a lien on a customer's funds, or otherwise earmarking the customer's funds for payment of specific utility bills according to a predetermined schedule as triggered by a host server 106.

In some embodiments, UPMS 110 includes at least one communication interface 300, at least one processor 302, and at least one memory 304 (e.g., a memory component, element or device). UPMS 110 is configured to utilize interface 300, processor 302, and memory 304 for executing software to exchange information (e.g., via an API-API exchange) between a host server 106 (FIG. 1) and/or utility servers 108 (FIG. 1) to implement guaranteed utility bill payment and settlement. In some embodiments, packets or message traffic (e.g., payment requests, payment information, transaction information, or the like) is sent, received and/or otherwise communicated or exchanged between UPMS 110 and other network entities via communication interface 300. Although only one communications interface 300 is illustrated, one or more additional communications interfaces 300 may be provided whereby connections to the network 104 (FIG. 1) and other entities are established. That is, communications interface 300 may include an interface by which packet data messages are received, sent, and/or exchanged.

UPMS 110 may include a hardware computing device and/or a computing platform including a communications interface 300 by which UPMS 110 transfers and exchanges electronic payment information, financial transaction data, payment (e.g., card or account) data, and any other information by which UPMS 110 can allocate funds and promote settlement of specific utility bills according to a predetermined schedule. UPMS 110 is configured to receive an indication that a customer authorizes payment of one or more utility bills, designate funds by placing a hold on funds needed for the payment, and optionally receive and store payment information for use in making recurring payments.

In some embodiments, processor 302 includes a microprocessor, such as a central processing unit (CPU), or any other hardware-based processor unit. Processor 302 is configured to execute and/or utilize software to communicate with host server 106 (FIG. 1) and multiple utility providers, or servers 108 associated therewith, for guaranteeing electronic payments, so that settlement can occur according to a predetermined schedule in accordance with a service established with and/or provided by host server 106 (FIG. 1).

In some embodiments, UPMS 110 further comprises a utility bill allocation and payment module (UBAPM) 306 executed by processor 302 and stored in memory 304. UBAPM 306 may include hardware, software and/or firmware components for implementing guaranteed payment of utility bills as described herein. In one exemplary implementation, UBAPM 306 includes functionality for receiving billing information, applying liens or holds to funds, and manage or divide the funds to various entities (e.g., utility providers via utility servers 108, FIG. 1) for facilitating settlement. UBAPM 306 is configured to store the payment information, such as a card number or account number, in storage 308 until it receives an electronic indication that funds should be allocated and/or a specific utility provider is to be paid. Storage 308 can comprise any type of storage element, component, or device, not limited to a database, a data table, a cache, a storage drive, or any other collection of records or information including payment information for processing on a recurring basis.

In some embodiments, UPMS 110 includes functionality for reading, parsing, and/or otherwise processing APIs to determine a payment amount and/or a day or time for releasing funds to one or more utility providers. Notably, UPMS 110 is configured to leverage APIs and communicate with host server (106, FIG. 1) to obtain specific payment amounts and billing schedules, as well as convey transactional information to host server 106 (FIG. 1) once a utility bill is paid.

In some embodiments, memory 304 (e.g., a memory element or device) of UPMS 110 includes a random access memory (RAM), a read only memory (ROM), an optical read/write memory, a cache memory, a magnetic read/write memory, a flash memory, or any other non-transitory storage media. In one embodiment, processor 302 and memory 304 may be used to execute and manage the operation of UBAPM 306. In some embodiments, memory 304 and/or storage 308 include any medium that is configured to store (e.g., locally) payment data used in processing payments and settlement to different utility providers.

Although FIG. 3 depicts UPMS 110 as a single node or network element, UPMS 110 may further include a plurality of network elements, a plurality of network components, etc., without departing from the scope of the instant subject matter. In some embodiments, UPMS 110 allocates funds for electronically guaranteeing payment of utility bills collected and communicated from a host server 106. UPMS 110 may include multiple processors, memory elements, interfaces, or the like.

Notably, host server 106 and/or UPMS 110 each include special purpose computing devices or machines having hardware components (e.g., one or more processor units, memory, and network interfaces) configured to execute hardware and software elements (e.g., APIs, packets, modules, etc.) for the purposes of performing one or more aspects of the disclosed subject matter. In addition, it should be noted that host server 106 and/or CMS 110 and the components or functionality thereof constitute special purpose computers that improve the technological field pertaining to guaranteeing electronic payments for public and/or private utilities by providing mechanisms to earmark or designate funds thereby safeguarding the funds until a settlement date that is predetermined according to a predetermined schedule. This obviates the need for manual processes and expands access of utilities to individuals that may otherwise lack access.

It will be appreciated that FIG. 3 is for illustrative purposes only and that various components, their locations, and/or their functions described above in relation to FIG. 3 may be changed, altered, added, integrated, segregated, or removed. For example, some components and/or functions may be separated or combined into more than one entity.

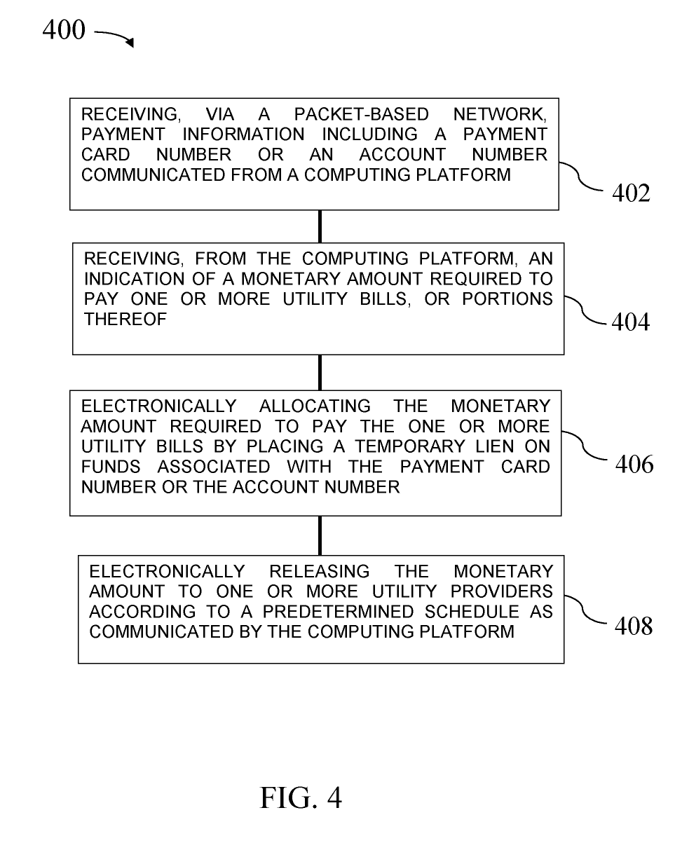

FIG. 4 is a schematic block diagram illustrating an exemplary process 400 for electronically guaranteeing payment of utility bills according to an embodiment of the subject matter described herein. A host server 106 (FIG. 1) and/or a UPMS 110 (FIG. 3) collectively interact and exchange electronic information for collecting or consolidating utility bills, allocating funds to pay the utility bills, and releasing funds to pay the utility bills according to a predetermined schedule. The predetermined schedule may recur daily, weekly, bi-weekly, monthly, or the like, as prescribed by terms set forth during enrollment in a service provided via host server 106 on behalf of utility providers.

In some embodiments, host server (e.g., 106, FIG. 3) includes a computing platform having at least one processor for receiving payment information from multiple privately hosted utility servers and scheduling recurring payments. UPMS 110 (FIG. 3) is configured to allocate a customer's funds and place a lien on the funds so that the funds remain available or guaranteed until settlement occurs at one or more utility servers (e.g., 108, FIG. 1) according to the predetermined schedule. Electronic processes shown and described herein advantageously obviate the need for manually processing utility bills.

In block 402, UPMS (e.g., 110, FIG. 3) receives, via a communications network, payment information including a payment card number or an account number communicated from a computing platform (e.g., host server 106, FIG. 1). Notably, the computing platform is a single platform for consolidating a plurality of utility bills by invoking one or more APIs to determine a billed amount from each of a plurality of privately hosted utility servers and display the plurality of utility bills to a customer

In block 404, UPMS receives, from the computing platform, an indication of a monetary amount required to pay one or more utility bills, or portions thereof.

In block 406, UPMS electronically allocates the monetary amount required to pay the one or more utility bills by placing a temporary lien on funds associated with the payment card number or the account number. In some embodiments, electronically allocating the monetary amount required to pay the one or more utility bills comprises pulling money from an account associated with the payment card number or the account number via APIs.

In block 408, UPMS electronically releases the monetary amount to one or more utility providers according to a predetermined schedule and/or percentage as communicated by the computing platform. Upon releasing the monetary amount, UPMS 110 communicates transaction information (e.g., transaction history) to the computing platform. The transaction information includes a transaction amount, a transaction date, a merchant code, a transaction code, combinations thereof, or the like.

In some embodiments, UPMS 110 releases the monetary amount to multiple different utility providers according to a prioritized list. That is, utility providers having a priority that is higher than other utility providers are paid in advance of the other utility providers.

It will be appreciated that exemplary process 400 is for illustrative purposes only and that different and/or additional actions may be used. It will also be appreciated that various actions associated with exemplary process 400 may occur in a different order or sequence.

As noted above, host server 106 (FIG. 1) and/or UPMS 110 (FIG. 3) and/or the functionality of each as described herein constitute a special purpose computer. Further, it will be appreciated that host server 106 (FIG. 1) and/or UPMS 110 (FIG. 3) described herein can improve the technological field pertaining to packet communications for allocating funds used to settle utility bills. The coordination, scheduling, management, allocation, and settlement of utility bills via host server 106 (FIG. 1) and UPMS 110 (FIG. 3) is necessarily rooted in computer technology in order to overcome a problem specifically arising in the realm of computer networks, for example, by guaranteeing, via a computing platform, electronic payments via electronic fund allocation in addition to consolidating, at a single computing platform, multiple utility bills.

Systems, methods, and computer readable media for electronically guaranteeing payment of utility bills may provide, for example and without limitation, one or more of the following beneficial technical effects: facilitating electronic payments; guaranteeing electronic payments by electronically allocating or holding funds; electronically placing and releasing liens on funds; minimizing and/or eliminating the need to manually process, deliver, and/or collect utility bill payments; electronically release funds for a specified amount according to a predetermined schedule and/or prioritized list; guaranteeing recurring payments; more efficient utility bill payment systems; increased assurance that a customer can pay for a utility; and/or payment systems that are more efficient, transparent, and/or beneficial to all parties to a transaction (e.g., the customer, collection host server, and/or merchant utility provider).

While the subject matter has been described herein in reference to specific aspects, embodiments, features, and illustrative embodiments, it will be appreciated that the utility of the subject matter is not thus limited. Rather, the utility extends to and encompasses numerous other variations, modifications and alternative embodiments, as will suggest themselves to those of ordinary skill in the field of the present subject matter, based on the disclosure herein.

Various combinations and sub-combinations of the structures and features described herein are contemplated, and will be apparent to a skilled person having knowledge of this disclosure. Any of the various features and elements as disclosed herein can be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

What is claimed is:

1. A method for electronically guaranteeing payment of bills, the method comprising:
at a utility payment management server (UPMS) including at least one processor:
receiving, via a communications network, payment information including a payment card number or an account number communicated from a computing platform;
receiving, from the computing platform, an indication of a monetary amount required to pay one or more bills, or portions thereof;
electronically allocating the monetary amount required to pay the one or more bills by placing a temporary lien on funds associated with the payment card number or the account number; and
electronically releasing the monetary amount to one or more providers according to a predetermined schedule as communicated by the computing platform.

2. The method according to claim 1, further comprising consolidating, at the computing platform, a plurality of bills by invoking one or more application programming interfaces (APIs) to determine a billed amount from each of a plurality of privately hosted utility servers.

3. The method according to claim 2, further comprising displaying, by the computing platform, the billed amount communicated from each of the plurality of privately hosted utility servers.

4. The method according to claim 1, further comprising communicating transaction information to the computing platform after electronically releasing the monetary amount to the one or more utility providers.

5. The method according to claim 4, wherein the transaction information includes a transaction amount, a transaction date, a merchant code, or a transaction code.

6. The method according to claim 1, wherein the computing platform is a customer facing platform that is accessible by a customer, the UPMS, and the providers.

7. The method according to claim 1, wherein the predetermined schedule is a weekly payment schedule, a bi-weekly payment schedule, or a monthly payment schedule.

8. The method according to claim 1, further comprising electronically releasing the monetary amount to multiple different providers according to a prioritized list.

9. The method according to claim 1, wherein electronically allocating the monetary amount required to pay the one or more bills comprises pulling money from an account associated with the payment card number or the account number via one or more application programming interfaces (APIs).

10. A system for electronically guaranteeing payment of bills, the system comprising:
a computing platform configured to communicate payment information and an indication of a monetary amount required to pay one or more bills, or portions thereof, across a communications network; and
a utility payment management server (UPMS) comprising at least one processor, wherein the UPMS is configured to receive the payment information and the indication of the monetary amount from the computing platform, electronically allocate the monetary amount required to pay the one or more bills by placing a temporary lien on funds associated with the payment card number or the account number, and electronically release the monetary amount to one or more providers according to a predetermined schedule as communicated by the computing platform.

11. The system according to claim 10, wherein the computing platform consolidates a plurality of bills by invoking one or more application programming interfaces (APIs) to determine a billed amount from each of a plurality of privately hosted servers.

12. The system according to claim 11, further wherein the computing platform is configured to display the billed amount communicated from each of the plurality of privately hosted servers.

13. The system according to claim 10, wherein the UPMS communicates transaction information to the computing platform after releasing the monetary amount to the one or more providers.

14. The system according to claim 13, wherein the transaction information includes a transaction amount, a transaction date, a merchant code, or a transaction code.

15. The system according to claim 10, wherein the computing platform is a customer facing platform that is accessible by a customer, the UPMS, and the providers.

16. The system according to claim 10, wherein the predetermined schedule is a weekly payment schedule, a bi-weekly payment schedule, or a monthly payment schedule.

17. The system according to claim 10, wherein UPMS releases the monetary amount to multiple different providers according to a prioritized list.

18. The system according to claim 10, wherein the UPMS pulls the monetary amount from an account associated with the payment card number or the account number via one or more application programming interfaces (APIs).

19. The system according to claim 10, wherein the bills include payment for electricity, power, gas, water, or sewage services.

20. The system according to claim 10, wherein the bills include payment for a neighborhood association fee, a school association, tuition, an insurance premium, or a workers union membership.

21. A non-transitory computer readable medium having stored thereon executable instructions that when executed by the processor of a computer control the computer to perform steps comprising:
receiving, via a communications network, payment information including a payment card number or an account number communicated from a computing platform;
receiving, from the computing platform, an indication of a monetary amount required to pay one or more bills, or portions thereof;
electronically allocating the monetary amount required to pay the one or more bills by placing a temporary lien on funds associated with the payment card number or the account number; and
electronically releasing the monetary amount to one or more providers according to a predetermined schedule as communicated by the computing platform.
